(19) United States
(12) Patent Application Publication
(10) Pub. No.: US 2022/0397168 A1
(43) Pub. Date: Dec. 15, 2022

(54) Brake Dust Particle Filter, Disc Brake Assembly, Use of a Filter, and Method for Filtering Air Laden with Brake Dust

(71) Applicant: MANN+HUMMEL GmbH, Ludwigsburg (DE)

(72) Inventors: Tobias Woerz, Leutenbach (DE); Lukas Bock, Bietigheim (DE); Thomas Jessberger, Asperg (DE); Andreas Klinser, Ludwigsburg (DE); Benedikt Weller, Steinheim (DE); Volker Kuemmerling, Bietigheim-Bissingen (DE); Coskun Evlekli, Waiblingen (DE); Soeren Jurgenson, Nordheim (DE); Florian Keller, Ludwigsburg (DE)

(21) Appl. No.: 17/836,490

(22) Filed: Jun. 9, 2022

(30) Foreign Application Priority Data
Jun. 9, 2021 (DE) 102021114796.4

(51) Int. Cl. F16D 65/00; F16D 55/226

(52) U.S. Cl. CPC F16D 65/0031; F16D 55/226

(57) ABSTRACT

A brake dust particle filter for a disc brake assembly with brake disc and brake caliper has a filter housing with opposed first and second side walls, a circumferential wall section extending at least partially circumferentially, and an end wall. The first and second side walls are connected to each other by the circumferential wall section and/or by the end wall. A filter housing interior extends from a side of the filter housing facing the brake caliper along the first and second side walls and the circumferential wall section to the end wall. An air-permeable filter wall arranged in the filter housing interior has a filter wall circumferential section that is radially spaced from the circumferential wall section and divides the filter housing interior into a raw air side and a clean air side. The clean air side extends between filter wall circumferential section and first circumferential wall section.

### BACKGROUND OF THE INVENTION

The present invention concerns a brake dust particle filter which is suitable for retaining particles that are generated during a braking event by abrasion at a brake disc and/or brake pads. Moreover, a disc brake assembly, in particular for a motor vehicle, provided with a brake dust particle filter is proposed. Furthermore, the use of the brake dust particle filter for reducing brake dust emissions of disc brakes as well as a method for filtering brake dust particles is proposed.

Disc brakes with a filter that absorbs the abraded particles of brake pads and brake discs in a housing that is enclosing a brake disc are disclosed in CH 675899. Therein, in a multi-layer filter medium which is facing the externally ventilated brake disc, an insert with guide elements for discharging the abraded particles is embedded in the interior of the filter medium.

U.S. 2010/0096226 discloses a filter for externally ventilated disc brakes in which laterally of the brake disc a respective shroud is provided. From a gap between the brake disc and an oppositely positioned near side wall of the shroud, air that is contaminated with brake dust is sucked through a filter material which is extending parallel to the brake disc in the shroud.

Brake dust particle filters of the aforementioned kind with ring segment-shaped filter housings and inwardly projecting tongues for supporting the inserted filter medium are moreover disclosed in WO 2019/048374.

### SUMMARY OF THE INVENTION

It is an object of the invention to provide improved measures for reducing brake dust emissions of disc brake assemblies.

According to a first aspect, a brake dust particle filter for a disc brake assembly with a brake disc and a brake caliper is proposed. The brake dust particle filter comprises:

a filter housing with a first side wall and an oppositely positioned second side wall which are connected to each other by means of an at least partially circumferentially extending circumferential wall section and/or an end wall, wherein an interior of the filter housing extends from an in particular open side facing the brake caliper along the side walls and/or the circumferential wall section to the end wall;

wherein the filter housing comprises in the interior at least one air-permeable filter wall with a filter wall circumferential section, which is present spaced apart radially relative to the circumferential wall section and divides the interior of the filter housing into a raw air side and a clean air side, wherein the clean air side extends between the filter wall circumferential section and the circumferential wall section. The filter wall circumferential section has the course of a cylinder wall surface whose central axis coincides in particular with an axis of rotation of the brake disc in the mounted state. One could also say that the filter wall circumferential section forms a cylinder wall surface segment.

In embodiments, the filter housing used in the brake dust particle filter can be a ring segment-shaped, for example, banana-shaped or helmet-shaped, filter housing. The interior of the filter housing is facing the brake disc in this context.

Based on the air-permeable filter wall, a flow channel is produced which provides for a defined pressure gradient between clean air side and raw air side. Since the filter wall comprises a filter wall circumferential section that is arranged radially at a distance from the circumferential wall sections, an effective filtration surface area of the filter wall can be enlarged. In this way, the degree of separation of the brake dust particle filter can be advantageously increased.

The proposed brake dust particle filter is suitable for any applications in disc brakes. In this context, the brake dust particle filter can be employed in stationary or mobile applications. As mobile applications, for example, motor vehicles such as passenger cars, trucks, buses, rail vehicles or the like are conceivable. Stationary, shaft brakes as they are used in wind or hydro power facilities can be provided with corresponding brake dust particle filters.

In embodiments of the brake dust particle filter, the filter housing is configured to enclose the brake disc between the side walls by a ring segment section. In the mounted state of the brake dust particle filter, in particular a friction surface of the brake disc extends between the side walls or between a side wall and the intermediate wall which delimits the chamber. One can say that the side walls and the intermediate wall extend substantially parallel to each other.

The resulting ring segment section can comprise, for example, an angle range of 90° or more. In embodiments, a ring segment angle of 40° to 270° results. In order to beneficially utilize the installation space, in particular in case of a passenger car brake assembly, ring segment angles between 45° and 180° have been found to be suitable. Suitable embodiments comprise in particular an angle range of 70° to 130°, preferably 80° to 120°.

The filter wall comprises the filter wall circumferential section and, as needed, further sections. The filter wall circumferential section extends in particular parallel to the circumferential wall section. The circumferential wall section can also be part of a circumferential wall that connects the two side walls to each other and in the mounted state is positioned opposite to a circumferential edge of the brake disc. The filter wall circumferential section can also connect the two side walls of the filter housing to each other. The filter wall circumferential section is in particular positioned in the filter housing such that in the mounted state it is positioned opposite the circumferential edge of the brake disc. In particular, the filter wall circumferential section in the mounted state is arranged between the circumferential edge of the brake disc and the circumferential wall section. The filter wall circumferential section and/or the entire filter wall can extend along the entire circumferential length of the filter housing.

In this context, the distance between the filter wall circumferential section and the circumferential wall section can be constant or vary. By defined distances between the filter wall circumferential section and the circumferential wall section, pressures can be varied in order to optimize the filtration performance of the brake dust particle filter.

According to an embodiment, the filter wall has at least one lateral section that is arranged axially displaced relative to one of the side walls, wherein the clean air side extends moreover between one of the side walls and the lateral section.

In particular, the filter wall does not extend exclusively opposite to the circumferential wall sections but also opposite to the first and/or second side wall. In this way, the total filter surface area is enlarged and the degree of separation is improved.

The lateral section (or the lateral sections) of the filter wall extend in particular perpendicularly away from the filter wall circumferential section. Between the lateral section of the filter wall and the oppositely positioned side wall, a predetermined distance can be present that forms a chamber for the clean air that is open, for example. The chamber is formed, for example, by the lateral section, the oppositely positioned side wall, the end wall, the filter wall circumferential section and/or the circumferential wall section (or the circumferential wall). The distance between the lateral section and the oppositely positioned side wall can be constant or vary. Due to defined distances between the lateral section and the oppositely positioned side wall, pressures can be varied in order to optimize the filtration performance of the brake dust particle filter. The filter wall is in particular formed as one piece with its lateral sections.

Should the filter wall comprise a lateral section extending opposite to the first side wall as well as one extending opposite to the second side wall, the filter wall has in particular a U-shape in section.

According to a further embodiment, the filter housing comprises two circumferential wall sections, wherein a first circumferential wall section extends axially from the first side wall in the direction toward the second side wall and a second circumferential wall section, aligned with the first circumferential wall section, extends axially from the second side wall in the direction toward the first side wall.

In case of the radially outer circumferential wall section, one can also speak of a circumferential wall surface of a ring segment-shaped filter housing.

According to a further embodiment, the air-permeable filter wall holds a filter medium. The filter wall is in particular covered across the entire surface by the filter medium. The filter wall comprises preferably an air-permeable grid.

It is conceivable to provide a filter medium, which is manufactured of a material that can resist the relatively high temperatures for a disc braking event, in the filter housing, in particular at the filter wall. The filter medium is suitable to bind or retain brake dust particles.

For example, the filter medium comprises a flat material with metal fibers, glass fibers, ceramic fibers and/or temperature-resistant plastic materials. Preferably, the employed filter material is stable at typical operating temperatures of disc brake assemblies, for example between −20° C. and 700° C. Known are metal fiber nonwovens that can be used as filter material. The air-permeable grid (also “cage”) can serve to support the filter medium. In this way, the filter medium can be imparted with stability. Moreover, the grid can prescribe the precise shape of the filter medium and thus of the filter wall. In this way, the shape of the filter wall can be adapted with minimal expenditure to the environment and/or to the filter housing.

According to a further embodiment, the filter medium is attached to one and/or both sides of the grid. The attachment is realized, for example, by a local adhesive connection.

According to a further embodiment, the filter medium has an inherent stiffness which is produced in particular by a partial sintering of the filter medium. When the filter medium has an inherent stiffness, in particular the grid can be dispensed with because the filter medium can support itself.

According to a further embodiment, the circumferential wall section (or the circumferential wall) and/or one of the side walls comprises at least one opening which enables exit of the air from the clean air side to the exterior of the filter housing.

Such an opening (outflow opening) serves in particular to prevent an excess pressure at the clean air side. The opening can be located, for example, at a wall side of the housing between aligned circumferential wall sections and/or at one of the side walls.

According to a further embodiment, the filter housing comprises a protective wall which extends away from one of the side walls and/or the circumferential wall and is oriented such that it diverts the air exiting from the opening, in particular through a labyrinth.

The protective wall serves in particular to prevent that water passes through the opening to the clean air side of the filter. This is, for example, undesirable because an undesirable washout may take place. Moreover, the protective wall can prevent that dirt passes from the exterior to the clean air side of the filter wall and clogs the latter, which has negative effects on the filter capacity.

A diversion of the air through a labyrinth means in particular that the protective wall forms an air outlet channel in which the air is diverted several times. In this way, an entry of dirt and water through the air outlet channel is made more difficult.

According to a further embodiment, the protective wall is a part of one of the side walls and/or of the circumferential wall section that is angled. The protective wall is, for example, of a one part configuration together with one of the side walls and/or the circumferential wall section. In this way, the manufacture of the filter housing with protective wall is simplified. The protective wall forms in particular an apron that projects away from the side wall and/or the circumferential wall and covers the openings from the exterior. The protective wall extends, for example, outside of the walls of the filter housing and is arranged at a distance thereto.

According to a further embodiment, the opening is arranged oriented downwardly in a state of use or mounted state of the brake dust particle filter at a disc brake assembly.

According to a further embodiment, the filter medium is a flat material with metal fibers, glass ceramics and/or temperature-resistant plastic materials and/or is formed of a medium without folds.

According to a further embodiment, at least one of the side walls and/or the circumferential wall is/are embodied to be airtight. In this way, on the one hand, a pressure gradient is enabled and, on the other hand, it is prevented that dirt and/or water from the outside can reach the clean side.

According to a further embodiment, the filter housing comprises a circumferential wall which comprises the circumferential wall section, wherein the circumferential wall connects the first and the second side wall to each other, wherein the filter wall is positioned at least partially opposite the circumferential wall, and wherein the clean air side is designed as a chamber which is delimited by the filter wall and the circumferential wall.

In case the filter wall comprises furthermore lateral section(s), the chamber furthermore extends along the lateral section(s), between a respective lateral section and the oppositely positioned side wall.

According to a further embodiment, the filter housing comprises at least one fastening section that extends away from a side wall and is arranged opposite the circumferential wall section, wherein the filter wall is removably held indirectly or directly by means of the fastening section at the filter housing, in particular with the aid of a circumferential guide channel of the fastening section.

The filter wall is in particular removable and exchangeable as a whole from the filter housing. This is advantageous, for example, because the filter wall can be replaced by a new filter wall when the filter capacity of the filter medium has decreased due to use. In particular, it is not necessary to exchange the entire filter housing; instead, it is sufficient to replace the filter wall.

According to a further embodiment, the fastening section comprises an inner circumferential wall section extending radially from at least one side wall in axial direction to the interior and comprising at the end the circumferential guide channel, wherein the circumferential guide channel is preferably present as a deformation, in particular crimping, of the inner circumferential wall section.

Due to a circumferential guide channel formed in this way, the filter wall can be pushed with minimal expenditure into the filter housing and fastened and/or removed.

According to a second aspect, a disc brake assembly is provided with a brake disc, a brake caliper, and a brake dust particle filter according to the first aspect and/or according to an embodiment of the first aspect, wherein the filter housing spans across the brake disc in axial direction.

The filter housing covers in this context at least in sections a friction surface of the brake disc in radial direction along the circumferential direction. The brake disc assembly can have moreover one or a plurality of brake pads arranged at the brake caliper.

During braking, brake dust particles are generated substantially at the friction surface and at the brake pads which are acting thereon. Therefore, the brake dust particle filter is arranged with the open side of its filter housing as close as possible at the brake caliper. For example, a mounting situation results in which the circumferential wall extends opposite a brake disc edge.

The embodiments and features which have been described for the proposed brake dust particle filter apply likewise to the proposed disc brake assembly.

According to an embodiment, the circumferential wall section (or the circumferential wall) extends opposite a brake disc circumferential edge.

According to a further embodiment, the brake disc is an internally ventilated brake disc which comprises a brake disc circumferential surface with radial outflow openings for radial outflow of air. In the interior of the brake disc, air channels for cooling the brake disc extend so that the heated cooling air exits substantially radially at the outflow openings. It can be advantageous to configure the circumferential wall opposite the brake disc edge (in case of externally ventilated brake discs) or opposite the radial outflow openings so as to be airtight.

According to a third aspect, a use of the brake dust particle filter according to the first aspect or according to an embodiment of the first aspect for filtering air laden with brake dust particles in or at a disc brake assembly is proposed. The use of the brake dust particle filter is in particular suitable for motor vehicles in urban traffic. Disc brake assemblies in electric or hybrid operated vehicles as well as in vehicles with internal combustion engine are conceivable. Likewise, brake dust particle filters can be used in or at disc brake assemblies of rail vehicles such as trains or trams.

The embodiments and features described for the proposed brake dust particle filter apply likewise to the proposed use.

According to a fourth aspect, a method is proposed for filtering air laden with brake dust particles, in particular by means of a brake dust particle filter according to the first aspect or according to an embodiment of the first aspect, in or at a disc brake assembly which comprises a brake disc rotatable in a rotational direction, a brake caliper engaging across the brake disc in the region of a friction surface, and at least one brake pad. The method comprises:

In a filter housing which is downstream of the brake caliper in the rotational direction and which engages across the brake disc at the edge and circumferentially:
guiding an air/brake dust particle flow first in circumferential direction along a friction surface of the brake disc;
guiding the air/brake dust particle flow through the filter medium of the filter wall from the raw air side to the clean air side;
absorbing the brake dust particles of the air/brake dust particle flow by means of the filter medium being flowed through.

The embodiments and features described for the proposed brake dust particle filter apply likewise to the proposed method.

According to an embodiment, the method comprises furthermore: guiding the air/brake dust particle flow through the filter medium of the filter wall from the raw air side to the clean air side based on a defined pressure gradient between the raw air side and the clean air side.

According to an embodiment, the method comprises furthermore: discharging the filtered air from the clean air side through an opening in the circumferential wall and/or in one of the side walls.

The features described for the brake dust particle filter apply likewise to the disc brake assembly as well as the vehicle. Features in relation to the use of the brake dust particle filter or the method for filtering air that is laden with brake dust particles are transferable in particular functionally to the properties of the brake dust particle filter.

Further possible implementations of the invention comprise also combinations that are not explicitly mentioned of features or method steps described above or in the following in relation to embodiments. In this context, a person of skill in the art will add also individual aspects as improvements or supplements to the respective basic form of the invention.

Further embodiments of the invention are subject matter of the dependent claims as well as of the embodiments of the invention described in the following. In the following, the invention will be explained with the aid of embodiments with reference to the attached Figures in more detail.

### BRIEF DESCRIPTION OF THE DRAWINGS

FIG. 1 is a perspective view of an embodiment of a disc brake assembly.

FIG. 2 is a lateral plan view of the disc brake assembly according to FIG. 1.

FIG. 3 is a section view of the disc brake assembly according to FIG. 1.

FIG. 4 is a further section view of the disc brake assembly according to FIG. 1.

FIG. 5 is a lateral plan view of an embodiment of a filter housing of a brake dust particle filter for a disc brake assembly according to FIGS. 1-4.

FIG. 6 is a perspective view of the filter housing according to FIG. 5.

FIG. 7 is a perspective view of a first embodiment of a filter housing of a brake dust particle filter for a disc brake assembly.

FIG. 8 is a lateral plan view of the filter housing according to FIG. 7.

FIG. 9 is a section view of the filter housing according to FIG. 7.

FIG. 10 is a perspective view of a second embodiment of a filter housing of a brake dust particle filter for a disc brake assembly.

FIG. 11 is a section view of the filter housing according to FIG. 10.

FIG. 12 is a perspective view of a filter wall for the filter housing according to FIG. 10.

FIG. 13 is a perspective view of an insertion process of the filter wall according to FIG. 12 into the filter housing according to FIG. 10.

FIG. 14 is a section view of a modification of the filter housing according to FIG. 10.

FIG. 15 is a section view of a modification of the filter housing according to FIG. 7.

In the Figures, same or functionally the same elements, inasmuch as nothing to the contrary is indicated, are provided with the same reference characters.

### DESCRIPTION OF PREFERRED EMBODIMENTS

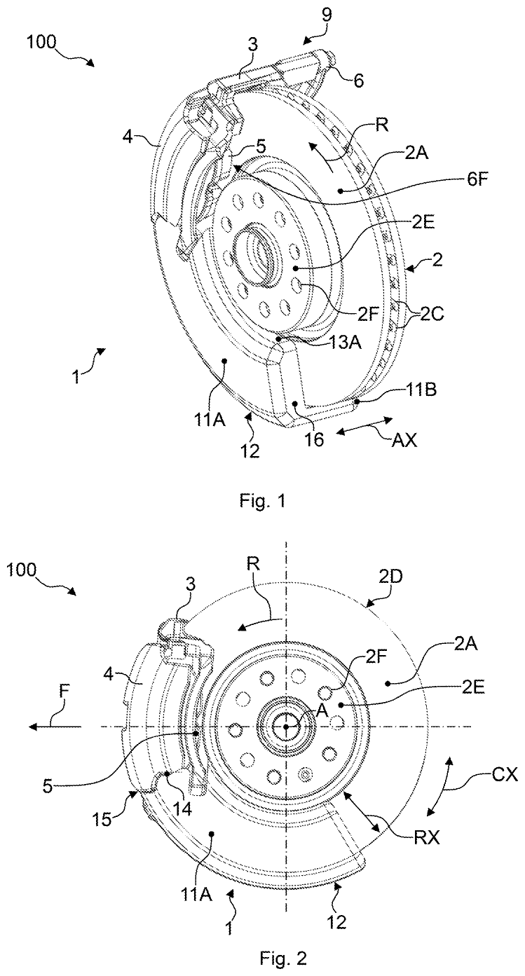

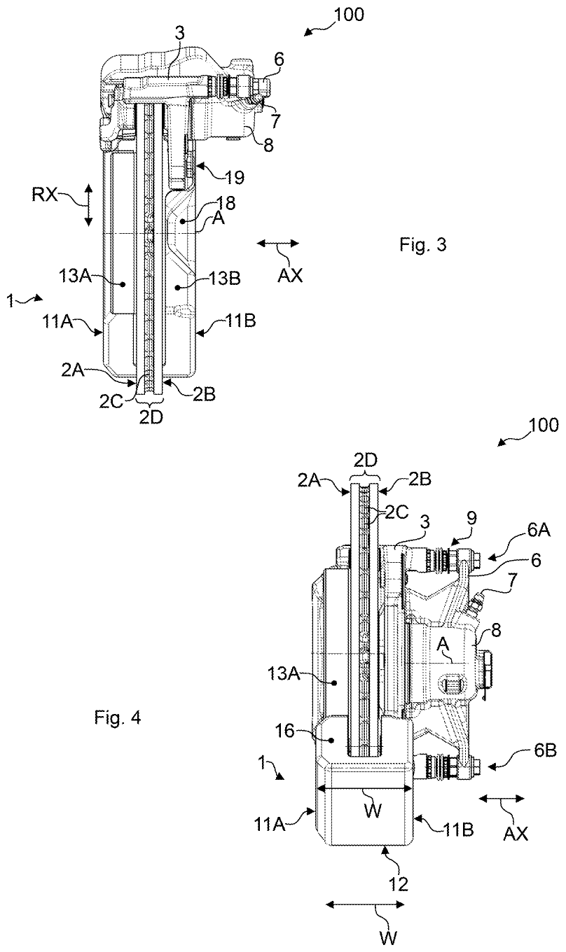

In FIGS. 1, 2, 3, and 4, different views of an embodiment of a disc brake assembly, for example, for a motor vehicle, are illustrated. In this context, in FIG. 1 a perspective view of the disc brake assembly 100, in FIG. 2 a lateral view, and in FIGS. 3 and 4 section views parallel to the axis of rotation A are illustrated.

The disc brake assembly 100 comprises a brake disc 2 which is provided with an inner ventilation action in the illustrated embodiment. The brake disc 2 has a radially inwardly positioned fastening plate 2E that comprises fastening openings 2F. In the Figures, only one opening 2F is provided with a reference number, respectively. By means of the fastening plate 2E and the fastening openings 2F, the brake disc 2 is fastened by means of suitable fastening means, for example, wheel bolts, to the wheel suspension so that a rotationally fixed coupling to the vehicle wheel, not illustrated here, or wheel rims is produced. At the circumferentially extending brake disc edge 2D (compare FIG. 3), one can see radially outwardly oriented outflow openings 2C. In operation of the brake which rotates in rotational direction R, airflows out of the outflow openings 2C for cooling the brake discs 2. For simplification, in the following a braking event upon forward travel is considered. In principle, the rotational direction can however also be reversed.

In the Figures, a forward rotational direction R opposite to the clockwise direction is indicated. It is referred to in the following as forward rotational direction R. The axis of rotation A can be seen in FIGS. 2, 3, and 4. Due to the orientation of the brake disc 2, an axial extension direction AX (compare FIGS. 1, 3, and 4), a radial extension direction RX (compare FIG. 3), and a circumferential extension direction CX (compare FIG. 2) result.

In FIG. 2, an installation situation of the brake disc 2 and a brake caliper 4 which engages across the brake disc 2 is substantially illustrated. The brake caliper 4 is coupled to a brake caliper holder 3 that also engages across the brake disc 2. At the brake caliper 4, brake pads 5, which by means of brake hydraulics 8 (compare FIGS. 3 and 4) are pushed against the friction surfaces 2A, 2B during the braking event, are arranged at both sides of the brake disc 2.

The brake caliper holder 3 as well as the brake caliper 4 are held by means of a floating support 9 by a brake caliper carrier 6. Due to a floating support 9, an automatic centering of the brake caliper 4 with the brake pads 5 is provided in relation to the brake disc 2 which is positioned between the two caliper arms of the brake caliper 4 or the two brake pads 5. In the illustrated embodiment, the brake caliper 4 in forward direction F is arranged in front of the axis of rotation A. Variants are also conceivable in which the brake caliper 4 is provided behind the axis A.

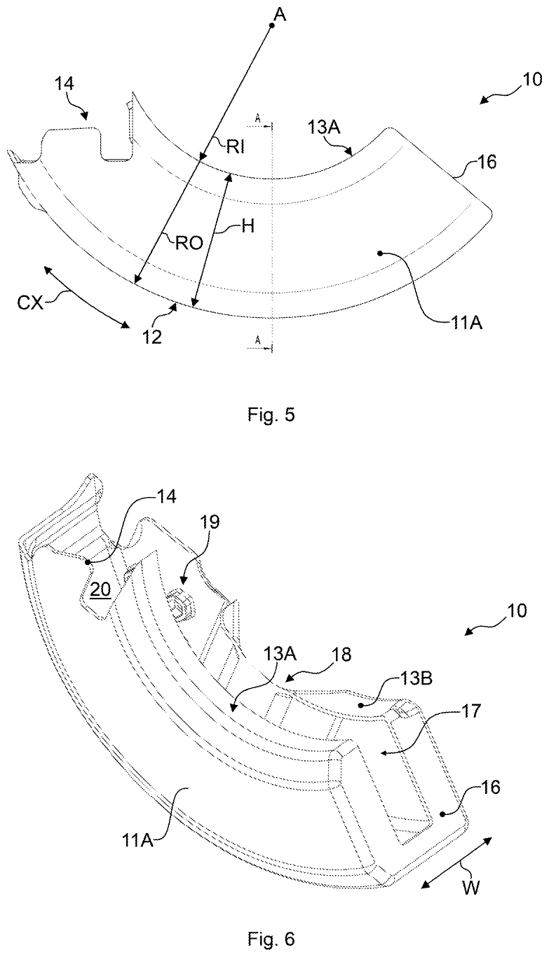

Since during the braking event the brake pads 5 push against the friction surfaces 2A, 2B of the brake disc 2, abraded particles are generated at the brake pads 5 and in principle also at the brake disc 2. A portion of these brake dust particles are entrained by the rotation R of the brake disc 2 in circumferential direction CX. Therefore, for catching this brake dust or the brake dust particles, a brake dust particle filter 1 is provided in rotational direction R downstream of the brake caliper 4. Detailed side views and perspective illustrations of the filter housing 10 of the brake dust particle filter 1 are illustrated in FIGS. 5 and 6.

The filter housing 10 of the brake dust particle filter 1 engages about a region of the brake disc 2 that is substantially ring segment-shaped. For this purpose, the brake dust particle filter 1 comprises a filter housing 10. The filter housing 10 has two oppositely positioned side walls 11A, 11B that are connected to each other by an outer circumferential wall 12 to an approximately U-shaped cross section. In the orientation of FIGS. 1, 3, and 4, an outer side wall 11A results which is facing away from the vehicle in the mounted state. The oppositely positioned side wall 11B (on the right side in the orientation of FIGS. 3 and 4) is referred to as inner side wall 11B because it is facing the interior of the vehicle. The brake disc 2 between the two side walls 11A, 11B is thus partially enclosed.

In radial direction opposite to the circumferential wall 12, inner circumferential edge sections 13A, 13B are provided. The outwardly positioned, radially inwardly positioned, and axially outwardly positioned circumferential edge section is identified by 13A. The radially inwardly positioned and axially inwardly positioned circumferential edge section is identified by 13B.

The filter housing 10 has an edge relative to the brake caliper 4 with a connection contour 14 so that a gap 15 is provided between the brake caliper 4 and the housing edge or connection contour 14. The housing edge 14 forms a brake caliper-side opening of the filter housing 10. The filter housing 10 extends in circumferential direction CX from the connection contour or an open side 14 of the filter housing 10 to an end wall 16. The end wall 16 connects the outer side wall 11A, the outer circumferential wall 12, and the inner side wall 11B to each other. Between the inner circumferential edge sections 13A, 13B, there is a ring-shaped slot 17 into which the brake disc 2 with its brake disc edge 2D can be inserted. The housing walls 11A, 11B, 12, 13A, 13B, 16 enclose a housing interior 20. The brake disc 2 projects into the housing interior 20, or the filter housing 10 encloses or engages about a ring segment of the brake disc 2. The filter housing 10 or installations in the brake dust particle filter 1 do not contact the brake disc 2.

In FIG. 5, possible dimensions of the filter housing 10 are illustrated. FIG. 5 shows a side view from the exterior of the disc brake assembly 100 in axial direction. One can see that the side walls, in particular the outer side wall 11A visible in FIG. 5, has a ring segment shape. The filter housing 10, viewed from the axis of rotation A, is delimited radially inwardly by the inner circumferential edge sections 13A, 13B (not illustrated) and radially outwardly by the outer circumferential wall 12. In this context, an inner radius RI can be provided by the distance of the inner circumferential edge sections 13A, 13B and an outer radius RO by the distance of the circumferential wall 12 from the axis of rotation A. The difference of the radii RO−RI can be referred to as height H of the filter housing 10. The length of the filter housing results from the extension along the circumference between the open side 14 facing the brake caliper 4 and the end wall 16. A width W of the filter housing 10 results in its axial extension by the distance between the two side walls 11A, 11B (compare FIGS. 4 and 6).

In operation of the disc brake assembly 100 and of the brake dust particle filter 11, an air flow in circumferential direction CX through the filter housing 10 along the axis of rotation R of the brake disc 2 is produced due to the rotation R of the brake disc 2.

In the interior 20 of the filter housing 10, the particles can deposit along the flow path in the filter housing 10 by adhesion forces at the inner wall or (not illustrated here) can be bound by suitable filter materials.

The filter housing 10 or the brake dust particle filter 1 is fastened with a suitable fastening means, for example, a screw, at the brake caliper holder 3. One can see fastening means 19 in FIGS. 3 and 6.

The installation space in the region of the disc brake assembly 100, in particular for a steered front axle of a vehicle, can have an influence on the housing shape of the brake dust particle filter 1. For example, the filter housing 10 has at the axially inner side a recessed region 18 in the direction toward the interior 20 of the filter housing 10 between the end wall 16 and the connection contour 14. Insofar, a changing width of the cross section of the filter housing 10 is provided along the circumferential direction CX.

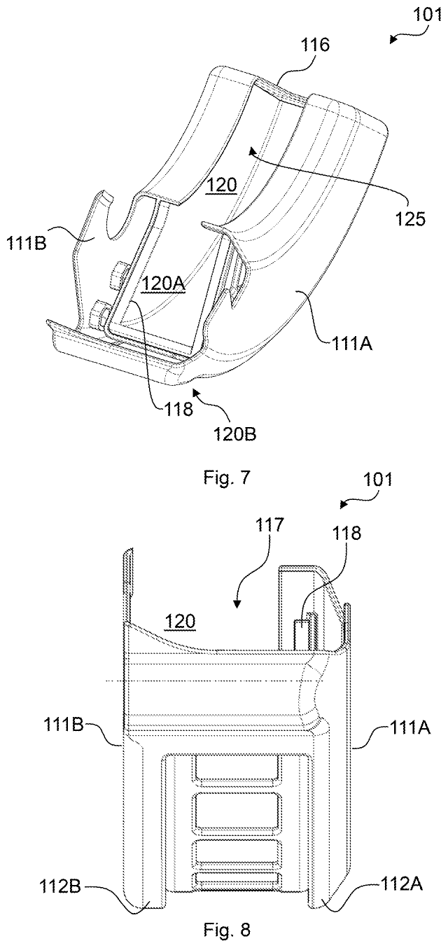

In FIGS. 7 to 15, some aspects of the employed filter housing 10 for embodiments of brake dust particle filters are explained. The filter housings or brake dust particle filters illustrated in the following are provided for use in disc brake assemblies 100, as described above. The reference characters which are used in the following correspond to the elements of the disc brake assembly and of the brake dust particle filter explained in connection with FIGS. 1 through 6, wherein 100 or 200 has been added to the respective reference numbers. For example, the end wall 116 of the filter housing 101 of FIG. 7 corresponds to the end wall 16 as it is referred to in FIGS. 1 to 6. The end wall 216 of the filter housing 201 of FIG. 10 corresponds to the end wall 16 as it is identified in FIGS. 1 through 6. Insofar, disc brake assemblies are illustrated which are provided with brake dust particle filters 1 according to the following Figures.

FIGS. 7 through 9 show a first embodiment of a filter housing 101 for a disc brake assembly 100. The filter housing 101 comprises instead of the afore described axially continuous circumferential wall 12 only circumferential wall sections 112A, 112B which along the circumferential direction CX extend away from the side walls 111A, 111B in the direction of the interior 120 in alignment with each other.

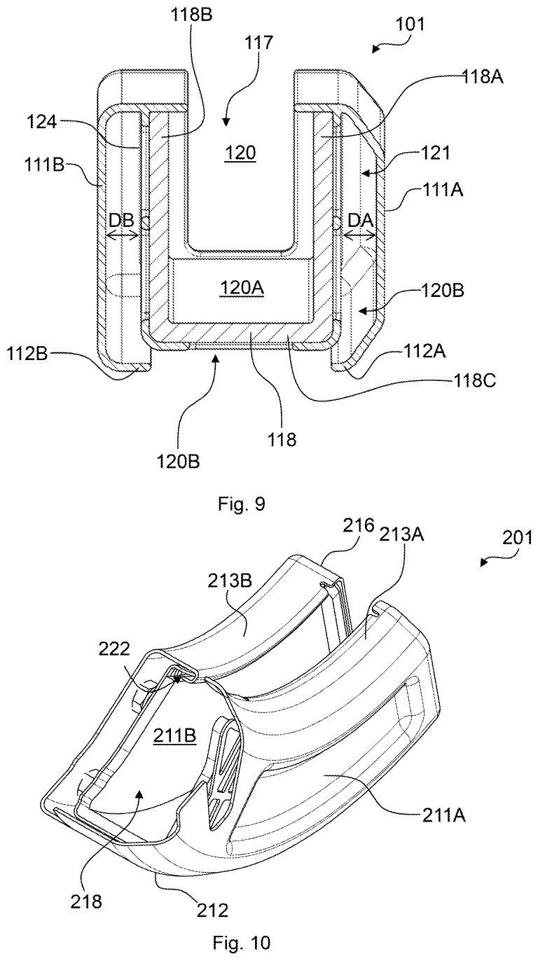

In the interior 120 of the filter housing 101, a filter wall 118 is arranged which extends spaced apart from the individual walls 111A, 111B, 112A, 112B of the filter housing 101. As illustrated in FIG. 9, the filter wall 118 is U-shaped in section. It comprises a filter wall circumferential section 118C which extends along the circumferential direction CX. In the mounted state, the filter wall circumferential section 118C is arranged opposite the brake disc edge 2D. Between the filter wall circumferential section 118C and the brake disc edge 2D, a distance along the radial direction RX is provided and amounts to between 0.5 and 2 cm.

The filter wall 118 comprises moreover two lateral sections 118A, 118B which substantially extend radially and perpendicularly away from the filter wall circumferential section 118C. The first lateral section 118A is arranged opposite the first side wall 111A so that a constant axial distance DA is provided between the first side wall 111A and the first lateral section 118A (see FIG. 9). The second lateral section 118B is arranged opposite the second side wall 111B so that a constant axial distance DB is provided between the second side wall 111B and the second lateral section 118B (see FIG. 9).

The filter wall 118 comprises a grid 124 and a filter medium 125 that is glued to an inner side of the grid 124 that is positioned opposite the brake disc 2. The filter medium 125 serves for receiving brake dust particles that are contained in the air that flows about the brake disc 2. The filter wall 118 serves thus for delimiting a raw air side 120A and a clean air side 120B of the interior 120. The clean air side 120B is formed by an open chamber 121 that extends between the filter wall 118 and the housing walls 111A, 111B, 112A, and 112B.

The distances DA, DB between the filter wall 118 and the housing walls 111A, 111 B, 112A, 112B lead to an advantageous pressure gradient between the raw air side 120A and the clean air side 120B. In this way, the air flow is guided through the filter wall 118 and efficiently filtered. Due to the free-standing filter medium 125 of the filter wall 118, an absolute filter surface area is moreover increased so that filtering the brake dust particles out of the air flow can be furthermore optimized.

Even though FIGS. 7 through 9 show an embodiment in which the filter wall 118 comprises two lateral sections 118A, 118B, it is also conceivable to eliminate one of the lateral sections 118A, 118B or both lateral sections 118A, 118B.

FIGS. 10 through 13 show a second embodiment of a filter housing 201 for a disc brake assembly 100. In contrast to the filter housing 101 of the first embodiment, the filter housing 201 comprises an axially continuous circumferential wall 212. Otherwise, the two embodiments are mostly identical.

The filter wall 218 has the property that it can be removed from the filter housing 201 and exchanged. FIG. 12 shows the filter wall 218 that has been removed from the housing 201. It comprises a grid 224 that serves for holding and reinforcing the air-permeable filter medium 225. Inner grid edges 224A are bent inwardly in the direction toward the interior 220 and form in this way a holding section for holding the filter wall 218 at the filter housing 201.

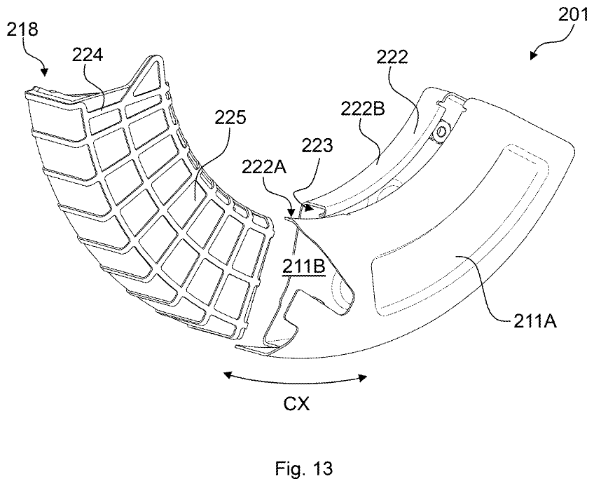

FIG. 13 shows how the filter wall 218 can be inserted into the filter housing 201 and removed. Both steps are realized by a movement of the filter wall 218 relative to the filter housing 201 along the circumferential extension direction CX.

For receiving and holding the filter wall 218, the filter housing 201 comprises a fastening section 222 with a circumferential guide channel 223. The fastening section 222 is formed at a radially inner section of the side walls 211A, 211B by a deformation of the side walls 211A, 211B. The fastening section 222 is thus formed as one piece together with the filter housing 201.

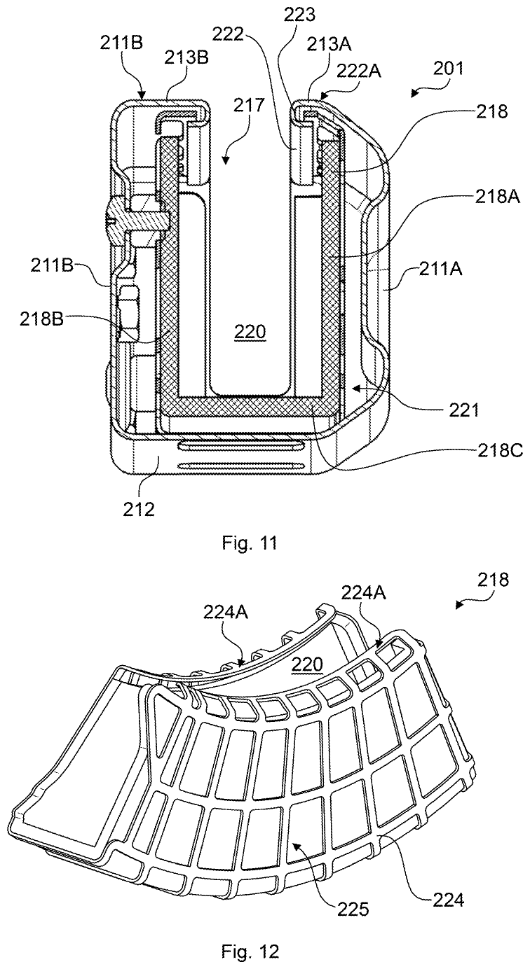

The fastening section 222, as illustrated in FIGS. 11 and 13, is formed in that the end sections 222A, 222B of the side walls 211A, 211B are bent toward each other axially in the direction toward the interior 220 so that the bent sections 222A, 222B substantially extend along the circumferential direction CX. The bent sections 222A, 222B (inner circumferential wall sections) comprise in turn a curved section which forms the circumferential guide channel 223. The circumferential guide channel 223 extends opposite the first and second side walls 211A, 211B and has dimensions that enable insertion of the holding section (inner grid edges 224A) of the filter wall 218.

The filter wall 218 can be removed from the filter housing 201 and can be replaced by a clean new filter wall 218. This is realized with minimal expenditure because the filter wall 218 can be inserted along the circumferential guide channel 223 into the filter housing 201 and can be held by means of the circumferential guide channel 223 in the interior 220.

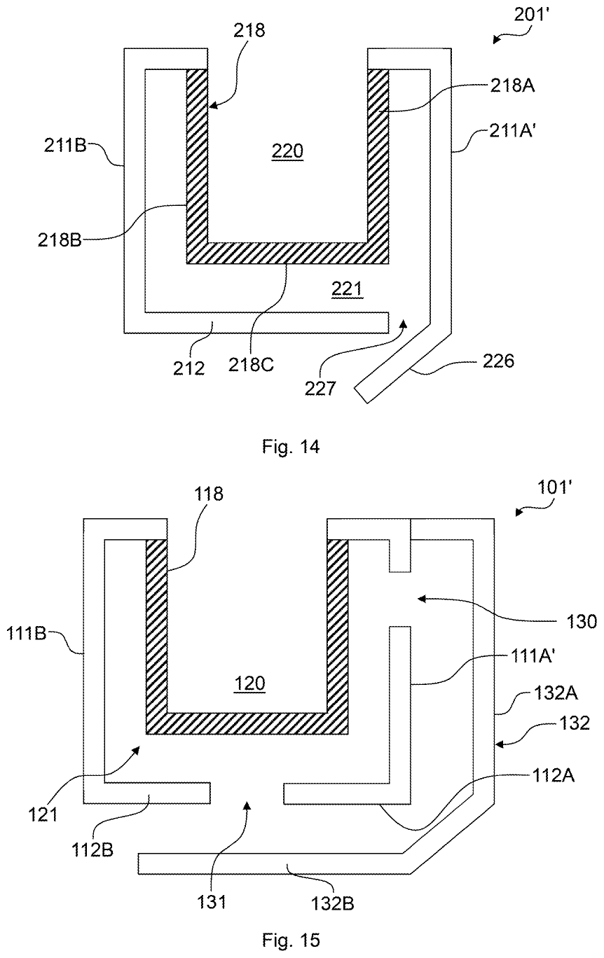

FIG. 14 shows a section view of a modification of the filter housing 201 according to FIG. 10. The filter housing 201′ illustrated in FIG. 14 differs from the filter housing 201 only in that in the circumferential wall 212 an opening 227 is provided through which the purified air (clean air) can exit from the chamber 221. In order to prevent that through the opening 227 dirt and water can reach the chamber 221, the side wall 211A′ comprises a protective wall 226 which is formed as one piece together with the side wall 211A′. The protective wall 226 is an angled section of the side wall 211A′ which projects past the opening 227 and protects it thus from dirt and liquid.

FIG. 15 shows a section view of a modification of the filter housing 101 according to FIG. 7. The filter housing 101′ illustrated in FIG. 15 differs from the filter housing 101 only in that in the side wall 111A′ an opening 130 is provided through which the purified air (clean air) can exit from the chamber 121. A further opening 131 is formed by the distance between the circumferential wall sections 112A, 112B. In order to prevent that through the openings 130, 131 dirt and water can reach the chamber 121, a protective wall 132 is provided about the side wall 111A1′. The protective wall 132 comprises a protective wall lateral section 132A that is spaced apart relative to the side wall 111A′ and thus covers the opening 130 as well as a protective wall circumferential section 132B which is positioned at an angle relative to the protective wall lateral section 132A, extends in circumferential direction CX, and covers the opening 131. The protective wall 132 projects thus past both openings 130, 131 and protects them thus from dirt and liquid.

Even though the invention presently has been described with the aid of preferred embodiments, it is not limited thereto but can be modified in many ways. For example, the filter housing 101′ of FIG. 15 can be symmetrically designed with respect to the opening 130 and the protective wall 132. This means that the second side wall 111B can also have an opening 130 and an oppositely positioned protective wall 132. Moreover, the filter wall 118 can also be designed to be removable from the filter housing 101. FIGS. 14 and 15 shows schematic illustrations in which the attachment of the filter wall at the housing is not explicitly shown but can be realized, for example, as in FIGS. 10 through 13.

### USED REFERENCE CHARACTERS

1 brake dust particle filter
2 brake disc
2A, 2B brake disc friction surface
2C outflow opening
2D brake disc edge
2E fastening plate
2F fastening opening
3 brake caliper holder
4 brake caliper
5 brake pad
6 brake caliper carrier
8 brake hydraulics
9 floating support
10 filter housing
11A (outer) side wall
11 B (inner) side wall
12 (outer) circumferential wall
13A (inner outwardly positioned) circumferential edge section
13B (inner inwardly positioned) circumferential edge section
14 connection contour
15 gap
16 end wall
17 slot
18 recessed region
20 interior
20A raw air side
20B clean air side
100 disc brake assembly
101 filter housing
101′ filter housing
111A (outer) side wall
111A′ (outer) side wall
111B (inner) side wall
112A circumferential wall section
112B circumferential wall section
116 end wall
117 slot
118 filter wall
118A lateral section
118B lateral section
118C filter wall circumferential section
120 interior
120A raw air side
120B clean air side
121 chamber
124 grid
125 filter medium
130 opening
131 opening
132 protective wall
132A protective wall lateral section
132B protective wall circumferential section
201 filter housing
201′ filter housing
211A (outer) side wall
211A′ (outer) side wall
211B (inner) side wall
212 (outer) circumferential wall
216 end wall
217 slot
218 filter wall
218A lateral section
218B lateral section
218C filter wall circumferential section
221 chamber
222 fastening section
222A bent section (inner circumferential wall section)
222B bent section (inner circumferential wall section)
223 circumferential guide channel
224 grid
224A inner grid edge
225 filter medium
226 protective wall
227 opening
A axis of rotation
AX axial extension direction
CX circumferential extension direction
DA distance
DB distance
F forward travel direction
R forward rotational direction
RI inner radius
RO outer radius
RX radial extension direction
W width

What is claimed is:

1. A brake dust particle filter for a disc brake assembly that comprises a brake disc and a brake caliper, wherein the brake dust particle filter comprises:
a filter housing comprising a first side wall, a second side wall positioned opposite the first side wall, a first circumferential wall section that extends at least partially circumferentially, and an end wall;
wherein the first side wall and the second side wall are connected to each other by the first circumferential wall section and/or by the end wall;
wherein an interior of the filter housing extends from a side of the filter housing that is facing the brake caliper in a mounted state of the brake dust particle filter along the first side wall, the second side wall, and the first circumferential wall section to the end wall;
at least one air-permeable filter wall arranged in the interior of the filter housing, wherein the at least one air-permeable filter wall comprises a filter wall circumferential section, wherein the filter wall circumferential section is radially spaced apart from the first circumferential wall section and divides the interior of the filter housing into a raw air side and a clean air side;
wherein the clean air side extends between the filter wall circumferential section and the first circumferential wall section.

2. The brake dust particle filter according to claim 1, wherein the at least one air-permeable filter wall comprises at least one lateral section arranged axially displaced opposite one of the first and second side walls, wherein the clean air side extends between the at least one lateral section and said one of the first and second side walls.

3. The brake dust particle filter according to claim 1, wherein the filter housing comprises a second circumferential wall section, wherein the first circumferential wall section extends axially away from the first side wall in a direction toward the second side wall, and wherein the second circumferential wall section is aligned with the first circumferential wall section and extends axially away from the second side wall in a direction toward the first side wall.

4. The brake dust particle filter according to claim 1, wherein the at least one air-permeable filter wall comprises a filter medium.

5. The brake dust particle filter according to claim 1, wherein the at least one air-permeable filter wall comprises an air-permeable grid and is covered across an entire surface area thereof with the filter medium.

6. The brake dust particle filter according to claim 5, wherein the air-permeable grid comprises two sides and the filter medium is attached to one and/or to both of the two sides of the grid.

7. The brake dust particle filter according to claim 1, wherein the filter medium comprises an inherent stiffness.

8. The brake dust particle filter according to claim 1, wherein the first circumferential wall section and/or one of the first side wall and the second side wall comprises at least one opening configured to enable air to exit from the clean air side to an exterior of the filter housing.

9. The brake dust particle filter according to claim 8, wherein the filter housing comprises a protective wall extending from the first side wall or the second side wall and/or from the first circumferential wall section, wherein the protective wall is oriented such that the protective wall diverts the air exiting through the at least opening from the clean air side to the exterior of the filter housing.

10. The brake dust particle filter according to claim 9, wherein the protective wall diverts the air through a labyrinth.

11. The brake dust particle filter according to claim 9, wherein the protective wall is an angled part of the first side wall or the second side wall and/or of the first circumferential wall section.

12. The brake dust particle filter according to claim 8, wherein the at least one opening is oriented downwardly in a state of use of the brake dust particle filter at the disc brake assembly.

13. The brake dust particle filter according to claim 1, wherein the filter wall circumferential section has a shape of a cylinder wall surface.

14. The brake dust particle filter according to claim 1, wherein at least one of the first side wall and the second side wall and/or the first circumferential wall section is airtight.

15. The brake dust particle filter according to claim 1, wherein the filter housing comprises a circumferential wall and the circumferential wall includes the first circumferential wall section, wherein the circumferential wall connects the first side wall and the second side wall to each other, wherein the at least one air-permeable filter wall is at least partially positioned opposite the circumferential wall, and wherein the clean air side is a chamber delimited by the at least one air-permeable filter wall and the circumferential wall.

16. The brake dust particle filter according to claim 1, wherein the filter housing comprises a fastening section extending away from the first side wall or the second side wall and arranged opposite the first circumferential wall section, wherein the at least one air-permeable filter wall is removably held indirectly or directly by the fastening section at the filter housing.

17. The brake dust particle filter according to claim 16, wherein the fastening section comprises a circumferential guide channel and the at least one air-permeable filter wall is removably held by the circumferential guide channel.

18. The brake dust particle filter according to claim 17, wherein the fastening section comprises radially inwardly an inner circumferential wall section extending away from the first side wall or the second side wall in an axial direction toward the interior of the filter housing, wherein the inner circumferential wall section comprises at an end thereof the circumferential guide channel.

19. The brake dust particle filter according to claim 18, wherein the circumferential guide channel is a deformation or a crimping of the inner circumferential wall section.

20. The brake dust particle filter according to claim 1, wherein the filter housing comprises a fastening section comprising a first end section of the first side wall and a second end section of the second side wall, wherein the first and second end sections are arranged opposite the first circumferential wall section, wherein the at least one air-permeable filter wall is removably held indirectly or directly by the first and second end sections at the filter housing.

21. The brake dust particle filter according to claim 20, wherein the first and second end sections each comprise a circumferential guide channel and the at least one air-permeable filter wall is removably held by the circumferential guide channels.

22. The brake dust particle filter according to claim 21, wherein the first and second end sections each comprise radially inwardly an inner circumferential wall section extending away from the first side wall or the second side wall, respectively, in an axial direction toward the interior of the filter housing, wherein the inner circumferential wall sections each comprise at an end thereof the circumferential guide channel, respectively.

23. The brake dust particle filter according to claim 22, wherein each circumferential guide channel is a deformation or a crimping of the inner circumferential wall section, respectively.

24. A disc brake assembly comprising:
a brake disc;
a brake caliper arranged at the brake disc;
a brake dust particle filter arranged at the brake disc and comprising:
a filter housing comprising a first side wall, a second side wall positioned opposite the first side wall, a circumferential wall section that extends at least partially circumferentially, and an end wall;
wherein the first side wall and the second side wall are connected to each other by the circumferential wall section and/or by the end wall;
wherein an interior of the filter housing extends from a side of the filter housing that is facing the brake caliper along the first side wall, the second side wall, and the circumferential wall section to the end wall;
at least one air-permeable filter wall arranged in the interior of the filter housing, wherein the at least one air-permeable filter wall comprises a filter wall circumferential section, wherein the filter wall circumferential section is radially spaced apart from the circumferential wall section and divides the interior of the filter housing into a raw air side and a clean air side;
wherein the clean air side extends between the filter wall circumferential section and the circumferential wall section;
wherein the filter housing spans across the brake disc in an axial direction of the disc brake assembly.

25. The disc brake assembly according to claim 24, wherein the circumferential wall section or a circumferential wall of the filter housing extends opposite a circumferential edge of the brake disc.

26. The disc brake assembly according to claim 24, wherein the brake disc is an internally ventilated brake disc comprising a brake disc circumferential surface with radial outflow openings configured to provide a radial outflow of air.

27. A method of filtering air laden with brake dust particles at a disc brake assembly, the method comprising:
using a brake dust particle filter according to claim 1 at the disc brake assembly.

28. A method for filtering air laden with brake dust particles at a disc brake assembly, comprising a brake disc rotatable in a rotational direction, a brake caliper engaging across the brake disc in a region of a friction surface, at least one brake pad, and a brake dust particle filter comprising a filter housing, the brake dust particle filter arranged downstream in the rotational direction relative to the brake caliper and engaging across the brake disc at a brake disc edge and circumferentially along the brake disc; the method comprising:
guiding an air/brake dust particle flow first in a circumferential direction along a friction surface of the brake disc;
guiding the air/brake dust particle flow through a filter medium of a filter wall of the brake dust particle filter from a raw air side to a clean air side of the brake dust particle filter;
absorbing brake dust particles from the air/brake dust particle flow by the filter medium as the air/brake dust particle flow passes through the filter medium.

29. The method according to claim 28, further comprising providing a defined pressure gradient between the raw air side and the clean air side for guiding the air/brake dust particle flow through the filter medium from the raw air side to the clean air side.

30. The method according to claim 28, further comprising discharging filtered air from the clean air side through an opening in a circumferential wall of the filter housing and/or in a side wall of the filter housing.
